(19) United States
(12) Patent Application Publication
(10) Pub. No.: US 2024/0057686 A1
(43) Pub. Date: Feb. 22, 2024

(54) Aerosol Generation Device Comprising a Communication Module, and Associated Communication System and Method

(71) Applicant: JT International SA, Geneva (CH)

(72) Inventors: Olayiwola Olamiposi Popoola, Walton-on-Thames (GB); Kyle Adair, Lisburn (GB); Peter Loveday, Epsom Surrey (GB)

(73) Assignee: JT International SA, Geneva (CH)

(21) Appl. No.: 18/266,953

(22) PCT Filed: Dec. 14, 2021
(86) PCT No.: PCT/EP2021/085668

§ 371 Date: Jun. 13, 2023

(30) Foreign Application Priority Data
Dec. 14, 2020 (EP) 20213734.5

(51) Int. Cl. A24F 40/65; H04B 5/00

(52) U.S. Cl. CPC A24F 40/65; H04B 5/0031; H04B 5/0081

(57) ABSTRACT

An aerosol generation device includes
a device NFC antenna; and
a device communication module connected to the device NFC antenna and configured to communicate with an external device using the device NFC antenna.

The device communication module is configured to transmit output data to the external device by encoding this output data into a carrier wave using the device NFC antenna and receive input data from the external device by decoding this input data from an electromagnetic wave received by the device NFC antenna.

### FIELD OF THE INVENTION

The present invention concerns an aerosol generation device comprising a communication module.

The present invention also concerns a communication system and a communication method associated to such an aerosol generation device.

### BACKGROUND OF THE INVENTION

Different types of aerosol generation devices are already known in the art. Generally, such devices comprise a storage portion for storing an aerosol forming precursor, which can comprise for example a liquid or a solid. A heating system is formed of one or more electrically activated resistive heating elements arranged to heat said precursor to generate the aerosol. The aerosol is released into a flow path extending between an inlet and outlet of the device. The outlet may be arranged as a mouthpiece, through which a user inhales for delivery of the aerosol. The heating system is powered by a battery presenting generally a rechargeable battery, as for example a lithium-ion battery. The power from the battery is usually controlled by a microcontroller basing for example on heating system characteristics such as the resistance of the heating coil.

Some known aerosol generation devices may also comprise a communication module carrying out a wireless communication capacity with an external device. Thus, it is possible to exchange wirelessly data between the aerosol generation device and the external device. This data can comprise various types of data useful for user and/or at least one of the devices. Such data can comprise for example user authentication data, user consumption data, device configuration data, etc.

Generally, the wireless communication capacity of an aerosol generation device is implemented using one of the known wireless protocols such for example Bluetooth or WiFi protocols. According to these protocols, it is necessary first to pair the aerosol generation device with the external device by exchanging identifiers and/or passwords between these devices. A particular advantage of these protocols is ensuring a relatively wide bandwidth able to transfer large data volumes.

However, using of these protocols increases significantly the power consumption of the aerosol generation device. This consumption may be significant even when the device is not used to transfer data but is simply paired with the external device to be ready to a data transfer. Additionally, in some cases, the pairing process with the external device may be laborious.

### SUMMARY OF THE INVENTION

One of the aims of the invention is to propose an aerosol generation device with a communication capacity presenting a very low energy consumption. Additionally, this communication capacity can be carried out without any particular pairing process.

For this purpose, the invention relates to an aerosol generation device comprising:
a device NFC antenna;
a device communication module connected to the device NFC antenna and configured to communicate with an external device using the device NFC antenna;
wherein the device communication module is configured to transmit output data to the external device by encoding this output data into a carrier wave using the device NFC antenna and receive input data from the external device by decoding this input data from an electromagnetic wave received by the device NFC antenna.

Thanks to these features, it is possible to implement a communication capacity of the aerosol generation device using an NFC (“Near-field-communication”) protocol which consumes low power and does not require a particular pairing process at least at the hardware level. Additionally, contrary to known aerosol generation devices having an NFC chip making it possible to transfer predetermined data as for example a device identifier, the device according to the invention can establish a “smart” bidirectional communication with the external device. Thus, the aerosol generation device can transfer not only predetermined data but also all kind of data which can be requested by the external device. Inversely and contrary to the existing devices with an NFC chip, the aerosol generation device can receive input data from the external device and process it according to its nature. After such procession, the aerosol generation device can generate an appropriate response to the external device and transmit it using its communication capacity.

According to some embodiments, further comprising a processing module configured to process the input data received by the device communication module and based on this processing, generate output data or extract output data from a memory, to transmit this output data to the external communication device through the device communication module.

Thanks to these features, the aerosol generation device can interact with the external device as a “smart” device. So, the aerosol generation device can respond to requests of the external device based on the content of this request.

According to some embodiments, the processing module is further configured to:
based on the input data, authenticate the external device;
transmit the output data to the external device only if the external device is authenticated.

Thanks to these features, it is possible to implement a secured authentication process on software level.

According to some embodiments, the input data corresponds to data generated by the external device in response to the output data transmitted by the device communication module.

Thanks to these features, it is possible to establish a “smart” communication process between the aerosol generation device and the external device.

According to some embodiments, the device NFC antenna is configured to transmit or receive electromagnetic waves of frequency substantially equal to 13.56 MHz.

Thanks to these features, a particular frequency can be used for wireless communication between the aerosol generation device and the external device.

According to some embodiments, the output data is encoded into the corresponding carrier wave using an amplitude-shift keying (ASK) technique.

Thanks to these features, useful data, also called payload, can be encoded into carrier waves.

According to some embodiments, the device communication module is configured to communicate with the external device according to a communication standard of type ISO/IEC 18092.

According to some embodiments, the device NFC antenna defines a rectangular shape with each side less than 15 mm.

Thanks to these features, it is possible to arrange the device NFC antenna within the aerosol generation device without affecting significantly its external design.

According to some embodiments, the data exchanged between the device communication module and the external device comprises at least one element chosen in the group:
user and/or aerosol generation device authentication data;
external device authentication data;
enabling/disabling data;
pairing data;
operational settings data;
status data;
diagnostics data;
programming data.

Thanks to these features, various types of data can be exchanged between the devices so as to simplify using of the aerosol generation device and/or enrich user experience.

According to some embodiments, said carrier wave is generated by the external device.

Thanks to these features, the device communication module may operate according to a passive mode.

According to some embodiments, said carrier wave is generated by the device communication module.

Thanks to these features, the device communication module may operate according to an active mode.

The invention also concerns a communication system, comprising:
an aerosol generation device as previously described;
an external device configured to communicate with the device communication module of the aerosol generation device.

According to some embodiments, the external device is configured to generate said input data to be received by the device communication module and encode this input data into a carrier wave to form said electromagnetic wave to be received by the device NFC antenna.

The invention also concerns a communication method carried out by the communication system as previously described, comprising the following steps:
generate a carrier wave;
modulate this carrier wave to encode into this carrier wave the input data to form an electromagnetic wave;
receive said electromagnetic wave;
decode the input data from said electromagnetic wave.

According to some embodiments, the communication method comprising the following steps:
process the received input data and based on this processing, generate or extract from a memory output data;
transmit this output data by modulating a carrier wave.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of a communication system according to the invention;

FIG. 2 is a schematic view of a carrier wave and a modulated carrier wave used by the communication system of FIG. 1; and

FIG. 3 is a flowchart diagram of a communication method according to a first embodiment of the invention, carried out by the communication system of FIG. 1;

FIG. 4 is a flowchart diagram of a communication method according to a second embodiment of the invention, carried out by the communication system of FIG. 1.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generation device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapor. Aerosol may include one or more components of the vaporizable material.

As used herein, the term “vaporizable material” or “precursor” or “aerosol forming substance” or “substance” is used to designate any material that is vaporizable in air to form aerosol. Vaporization is generally obtained by a temperature increase up to the boiling point of the vaporization material, such as at a temperature less than 400° C., preferably up to 350° C. The vaporizable material may, for example, comprise or consist of an aerosol-generating liquid, gel, wax, foam or the like, an aerosol-generating solid that may be in the form of a rod, which contains processed tobacco material, a crimped sheet or oriented strips of reconstituted tobacco (RTB), or any combination of these. The vaporizable material may comprise one or more of: nicotine, caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar.

As used herein, the term “external device” may refer to a device, which is able to establish a wireless data connection with the aerosol generation device as it is explained in the specification. Such an external device may be a mobile device like a mobile phone for example. Additionally, such an external device may be a smart device able to process at least some data received from the aerosol generation device or intended to be transmitted to the aerosol generation device. Such a smart device can be a smartphone, a smartwatch, a tablet computer, a laptop, a desktop computer or any other smart object implemented for example according to the IoT (“Internet of things”) technology. Such a smart device can be also another aerosol generation device similar to said aerosol generation device.

As used herein, the term “user and/or aerosol generation device authentication data” may refer to data exchanged between the aerosol generation device and the external device to authenticate the user and/or the aerosol generation device. In some embodiments, the aerosol generation device may be configured to operate only with an authenticated user or vaporizable material. According to a particular example, said data may comprise for example a user identifier which may be transmitted by the external device to the aerosol generation device and then compared with a stored identifier to activate/deactivate the operation of the aerosol generation device. According to another example, said data may comprise for example an aerosol generation device identifier or a vaporizable material identifier which may be transmitted by the aerosol generation device to the external device. In this case, upon reception of such an identifier, the external device may analyze it and transmit to the aerosol generation device an enabling/disabling signal to enable/disable its operation.

As used herein, the term “external device authentication data” may refer to data exchanged between the aerosol generation device and the external device to authenticate the external generation device. This data can comprise for example an external device identifier usable to authenticate it by the aerosol generation device.

As used herein, the term “enabling/disabling data” may refer to data exchanged between the aerosol generation device and the external device to activate/deactivate the operation of the aerosol generation device. Such data can for example comprise an enabling/disabling signal generated by the external device further to an authentication process performed for example using authentication data as explained above. According to another embodiment, the enabling/disabling data may be generated by the external device based on localization data. Thus, for example, in some areas, using of the aerosol generation device may be prohibited or restricted. In this case, upon detection of such an area, the external device may generate a disabling signal.

As used herein, the term “pairing data” may refer to data exchanged between the aerosol generation device and the external device to establish a connection between these devices using another communication protocol or a connection between the aerosol generation device and another external device using a predetermined communication protocol. Said communication protocol can be for example a wireless protocol offering a wider bandwidth in comparison with the protocol used to transfer said pairing information data, as for example a protocol based on Bluetooth or Wi-Fi technology. The pairing data may comprise a password, an identifier, a combination of both or any other information making it possible to pair said devices.

As used herein, the term “operational settings data” may refer to data exchanged between the aerosol generation device and the external device used to control the operation of the aerosol generation device. Thus, for example, said data may comprise settings used to control a heating system of the aerosol generation device as for example current/voltage values for supplying the heating system or duration of its activation. In variant, said data may comprises settings used to control any other component of the aerosol generation device. According to a particular embodiment, said settings are generated by the external device further to a user interaction with an appropriate human machine interface. In variant, said settings may be generated by analyzing data received by the external device from the aerosol generation device. According to a particular example, the external device may for example generate operational settings of the heating system based on vaporizable material data received from the aerosol generation device and characterizing the vaporizable material nature.

As used herein, the term “status data” may refer to data exchanged between the aerosol generation device and the external device relative to a status of the aerosol generation device or the external device or at least one component of such a device. Such a status may for example indicate that the corresponding device is in a standby mode or is being operated or a status of a component of such a device such for example the battery status which may be discharged or fully charged.

As used herein, the term “diagnostics data” may refer to data exchanged between the aerosol generation device and the external device relative to diagnostic of different internal components of the corresponding device. Thus, for example, the corresponding device may generate diagnostic data relative to the operation of each of its components and transfer this data to the other device. For example, such data can be generated by the corresponding device upon receiving a corresponding user request or upon detecting an operation error of at least one component of the device.

As used herein, the term “programming data” may refer to data exchanged between the aerosol generation device and the external device to modify at least one software component of the corresponding device.

As used herein, the term “standard of type XXX” may refer to any standard issued from a known standard XXX. Particularly, such a standard may refer to any version of the known standard XXX and may include any modification of the known standard XXX which may be considered as non-significant for a person skilled in the art in view of the teaching of the present specification.

As used herein, the term “near field” refers to an electromagnetic field created by an NFC antenna which allows wireless data exchanging with another NFC antenna. The near filed may for example be formed by a sphere formed around the corresponding NFC antenna, with a radius comprised between 1 cm and 10 cm, advantageously between 2 cm and 8 cm.

As used herein, the term “carrier wave” refers to an electromagnetic wave, notably to a radio wave used to carry encoded data. Thus, the carrier wave may present a sine wave of predetermined amplitude and frequency.

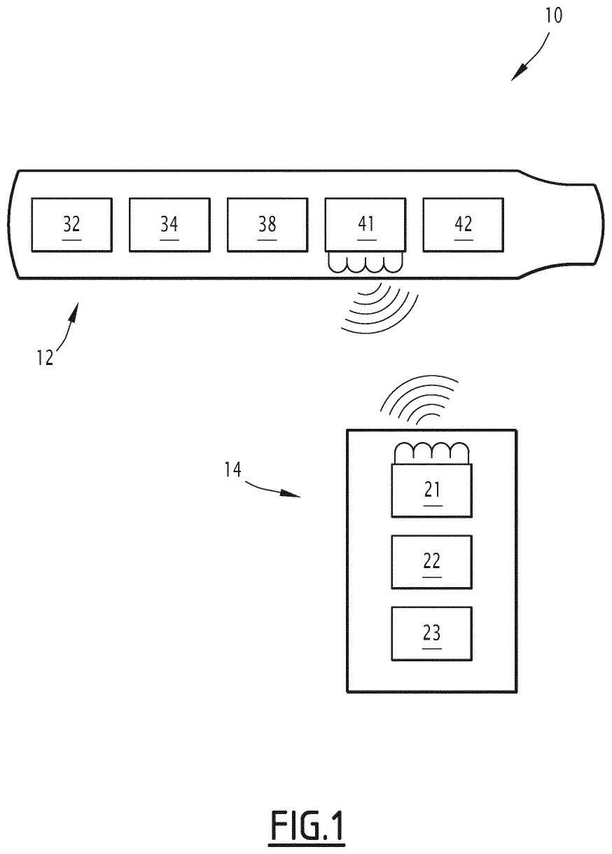

Referring to FIG. 1, the communication system 10 according to the invention comprises an aerosol generation device 12 and an external device 14.

The external device 14 corresponds to one of the external devices defined above. In the example of FIG. 1, the external device 14 is a smartphone. The external device 14 is able to communicate wirelessly with the aerosol generation device 12 using an NFC communication protocol, as it will be explained in further detail below. For this purpose, the external device comprises an NFC antenna 21, called hereinafter external NFC antenna 21, a communication module 22, called hereinafter external communication module 22, and a processing module 23, called hereinafter external processing module 23.

The external processing module 23 is able to process data in relation with the aerosol generation device 12. Particularly, the external processing module 23 is able to generate data intended to be transmitted to the aerosol generation device 12. As explained above, this data can be generated further to a user interaction with the corresponding interface or further to reception of particular data from the aerosol generation device 12. The external communication module 22 is configured to encode data intended to be transmitted to the aerosol generation device 12 into a carrier wave and to decode from electromagnetic waves received by the external NFC antenna 21 data transmitted notably by the aerosol generation device 12. Thus, the external communication module 22 is configured to carry out a bidirectional communication with a similar communication module according to the NFC communication protocol. According to different embodiments, this communication protocol may be implemented according to a communication standard of type ISO/IEC 18092 and/or ISO/IEC 14443. According to a particular embodiment of the invention, for encoding/decoding data, the external communication module 22 uses an ASK (“amplitude-shift keying”) technique. The external NFC antenna 21 refers to a known NFC antenna able to receive electromagnetic waves from a near field and emit to this new field electromagnetic waves formed by the external communication module 22. According to a particular example of the invention, the external NFC antenna 21 is able to receive/emit electromagnetic waves forming radio waves of frequency substantially equal to 13.56 MHz. The external NFC antenna 21 is for example supplied by an electrical source comprised in the external device 14.

The aerosol generation device 12 comprises a battery 32 for powering the device 12, a heating system 34 powered by the battery 32, a payload compartment 36 in contact with the heating system 34 and a processing module 38, called hereinafter device processing module 38, for controlling the operation of the aerosol generation device 12. The aerosol generation device 12 may further comprise other components performing different functionalities of the device 12. These other components are known per se and will be not explained in further detail below.

According to the invention and as it is shown on FIG. 1, the aerosol generation device 12 further comprises an NFC antenna 41, called hereinafter device NFC antenna 41, and a communication module 42, called hereinafter device communication module 42.

The battery 32 is for example a known battery designed to be charged using the power supply furnished by an external charger and to provide a direct current of a predetermined voltage.

The payload compartment 36 is designed to store the vaporizable material used to generate aerosol. Particularly, based on the nature of the vaporizable material, the payload compartment 36 can be designed to store the vaporizable material in a liquid and/or solid form. The payload compartment 36 can be fixed in respect with the body of the aerosol generation device 12 or removable from it. In the first case, the payload compartment 36 can be refilled with the vaporizable material. In the second case, the payload compartment 36 can present a replaceable cartridge (e.g., a pod or capsule containing e-liquid) or consumable (e.g., a tobacco rod) that can be removed and replaced by another one when the vaporizable material is no longer available. In some embodiments, the replaceable cartridge can be also refilled with the vaporizable material. In some examples, the payload compartment 36 may comprise a payload identifier making it possible to determine the nature of the vaporizable material and/or its composition.

The heating system 34 comprises a heater in contact with the payload compartment 36 or integrated partially into this compartment 36. Powered by the battery 32 and controlled by the processing module 38, the heater is able to heat the vaporizable material comprised in the payload compartment 36 to generate aerosol.

The device communication module 42 is for example similar to the external communication module 22, as explained above. Thus, as explained above, the device communication module 42 is configured to transmit output data to the external device by encoding this output data into a carrier wave using the device NFC antenna 41 and receive input data from the external device 14 by decoding this input data from an electromagnetic wave received by the device NFC antenna 41. As the external communication module 22, the device communication module 42 is able to implement a communication with the external communication module according to a communication standard of type ISO/IEC 18092 and/or ISO/IEC 14443 and encode/decode data using an ASK (“amplitude-shift keying”) technique.

Particularly, according to a first embodiment of the invention, the device communication module 42 is configured to transmit output data to the external device in a passive mode. In this case, the device communication module 42 is configured to encode the output data in a carrier wave generated by the external communication module 22. According to a second embodiment of the invention, the device communication module 42 is configured to transmit output data to the external device in an active mode. In this case, the device communication module 42 is configured to generate a carrier wave and encode the output data in this carrier wave.

The device NFC antenna 41 refers to a known NFC antenna able to receive electromagnetic waves from a near field and emit to this near field electromagnetic waves formed by the device communication module 42. As the external NFC antenna 21, the device NFC antenna 41 is able to receive/emit electromagnetic waves forming radio waves of frequency substantially equal to 13.56 MHz. According to a particular embodiment, the device NFC antenna 41 is arranged within the aerosol generation device 12. This antenna 41 may present reduced dimensions and form a rectangular shape. Thus, according to a particular example of the invention, the device NFC antenna defines a rectangular shape with each side less than 15 mm.

The device processing module 38 is configured to control the operation of the aerosol generation device 12. In particular, depending on different embodiments of the invention, the device processing module 38 is able to control the operation of the aerosol generation device 12 according to at least some of data received from the external device as for example user authentication data, enabling/disabling data, pairing data and/or operational settings data as explained above. The device processing module 38 is also able to process at least some of this data to generate for example aerosol generation device authentication data, pairing data, status data and/or diagnostics data intended to be transmitted to the external device 14. The operation of the device processing module can be modified using for example programming data, as explained above.

In some embodiments, the device processing module 38 is associated with an internal memory of the aerosol generation device 12 and is able to extract and eventually to process data stored in such a memory. For example, this memory can store device authentication data such for example a device identifier. In some examples, the data stored in the memory can be encrypted. In this case, the processing module 18 is able to process this data to decrypt it before sending for example to the external device 14 using the device communication module 42 and the device NFC antenna 41.

In some examples, the device processing module 38 and the external processing module 23 may exchange authentication data through the corresponding communications modules 22, 42 and NFC antennas 21, 41 in order to establish a secured connection between them. The authentication data exchanged between these modules 23, 38 may comprise user and/or aerosol generation device authentication data and external device authentication data as explained above. In case when the authentication is failed, the corresponding communication module 22, 42 is able to interrupt the communication with the other communication module 22, 42.

### Communication Method According to the First Embodiment

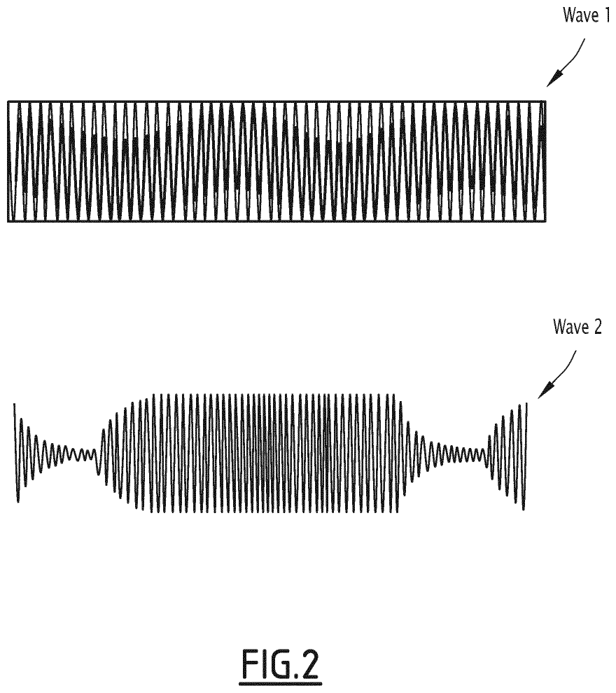

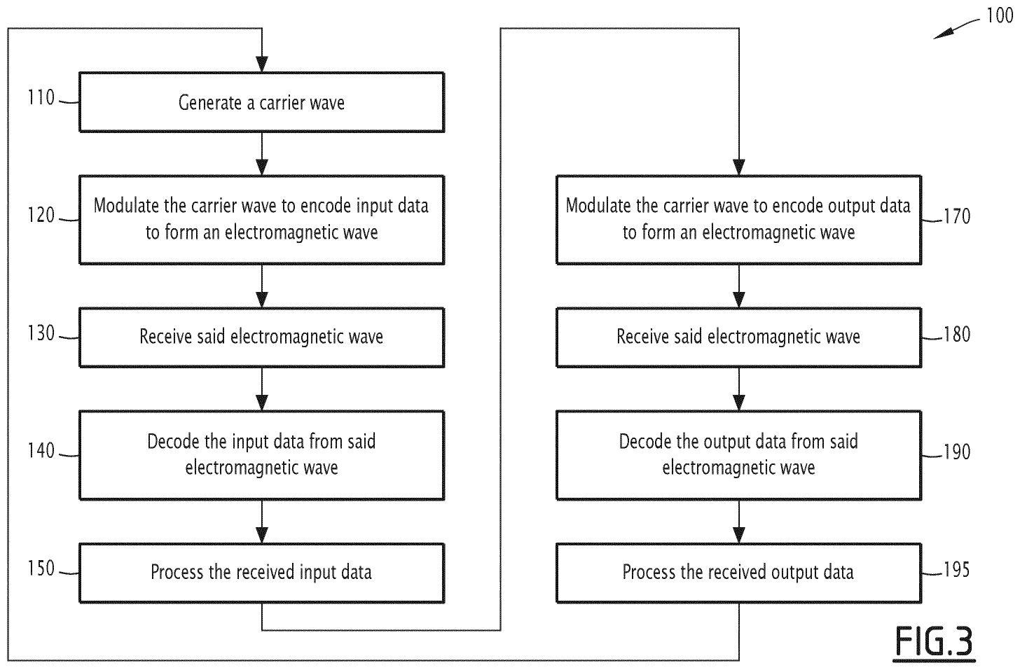

A communication method 100 according to the first embodiment of the invention will now be explained in reference to FIGS. 2 and 3. As mentioned above, in the first embodiment of the invention, the device communication module 42 operates according to the passive mode.

Initially, it is considered that that the device NFC antenna 41 is in the near field of the external NFC antenna 21. This position can be achieved when the user approaches the corresponding parts of the aerosol generation device 12 and the external device 14.

It is also considered that the external device 14 is intending to transmit data to the aerosol generation device 12 and receive response data from the aerosol generation device 12. Thus, in respect to the aerosol generation device 12, the communication method 100 comprises reception steps 110 to 150 of receiving input data and emission steps 170 to 190 of emitting output data, explained in further detail below. It should also be understood that in a variant of the present embodiment, the emission steps 170 to 190 may be performed before the reception steps 110 to 150.

During the initial step 110, the external communication module 22 generates a carrier wave. An example of such a carrier wave is shown on FIG. 2 with reference “wave 1”.

During the next step 120, the external communication module 22 modulates this carrier wave to encode into this carrier wave data intended to be transmitted to the aerosol generation device 12. The modulated carrier wave is then transmitted by the external NFC antenna 21 in form of an electromagnetic wave in the near field of this antenna. An example of such a modulated carrier wave is shown on FIG. 2 with reference “wave 2”.

During the next step 130, the operation of the device NFC antenna 41 is activated by energy received from the electromagnetic field created by the external NFC antenna 21. Then, the device NFC antenna 41 receives the electromagnetic wave from the external NFC antenna 21 and transmit it to the device communication module 42.

During the next step 140, the device communication module 42 decodes the data from the electromagnetic wave and transmits it to the device processing module 38.

During the next step 150, the device processing module 38 processes the data. Based on the nature of this data, the device processing module 38 controls for example the operation of the aerosol generation device 12 and/or generates output data to be transmitted to the external device 14. In this last case, the emission steps 170 to 190 of the communication method 100 are carried out.

During the next step 170, the device communication module 42 encodes data intended to be sent to the external device 14 by modulating the carrier wave emitted by the external NFC antenna 21 into the near field during the step 110. Thus, a modulated carrier wave similar to the wave referenced as “wave 2” on FIG. 2, is formed.

During the next step 180, the external NFC antenna 21 receives the modulated carrier wave and transmit it to the external communication module 22.

During the next step 190, the external communication module 22 decodes the data encoded into the modulated carrier wave and transmit it to the external processing module 23.

During the next step 195, the external processing module 23 processes the received data and based on its nature, ends the communication process with the aerosol generation device 12 or generates other data to be transmitted to this device. In this last case, the emission steps 110 to 150 are reiterated.

### Communication Method According to the Second Embodiment

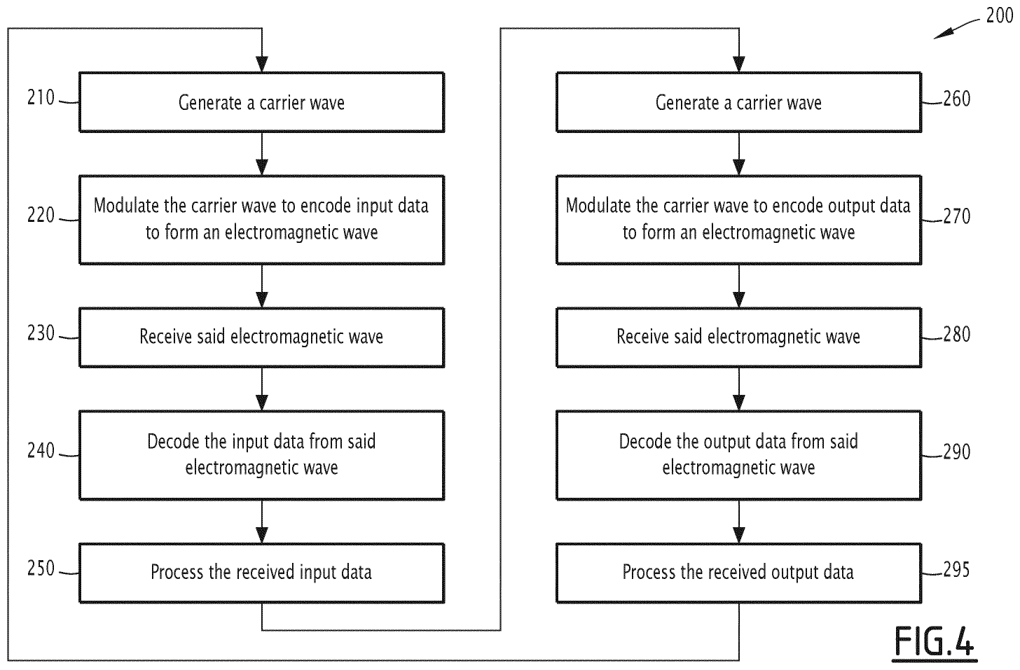

A communication method 200 according to the second embodiment of the invention will now be explained in reference to FIGS. 2 and 4. As mentioned above, according to the second embodiment of the invention, the device communication module 42 operates according to the active mode.

In this case, the communication method 200 according to the second embodiment comprises reception steps 210 to 250 similar respectively to the reception steps 110 to explained above. The communication method 200 according to the second embodiment further comprises emission steps 270 to 295 also similar respectively to the emission steps 170 to 195 explained above.

Contrary to the communication method 100 according to the first embodiment of the invention, the communication method 200 according to the second embodiment of the invention also comprises a step 260 carried out by the device NFC antenna 41 of the aerosol generation device 12 before the emission steps 270 to 295.

Particularly, during this step 260, the device NFC antenna 41 emits a non-modulated carrier wave similar to the carrier wave “wave 1” illustrated on FIG. 2. In this case, during the following step 270, the device communication module 42 generates and encodes its own carrier wave with the data intended to be transmitted to the external device 14. The other emission steps are similar to those explained above.

1. An aerosol generation device comprising:
a device NFC antenna; and
a device communication module connected to the device NFC antenna and configured to communicate with an external device using the device NFC antenna;
wherein the device communication module is configured to transmit output data to the external device by encoding the output data into a carrier wave using the device NFC antenna and receive input data from the external device by decoding the input data from an electromagnetic wave received by the device NFC antenna; and
wherein the input data corresponds to data generated by the external device in response to the output data transmitted by the device communication module.

2. The aerosol generation device according to claim 1, further comprising a processing module configured to process the input data received by the device communication module and based on the processing, generate output data or extract output data from a memory, to transmit the output data to the external communication device through the device communication module.

3. The aerosol generation device according to claim 2, wherein the processing module is further configured to:
based on the input data, authenticate the external device; and
transmit the output data to the external device only if the external device is authenticated.

4. The aerosol generation device according to claim 1, wherein the device NFC antenna is configured to transmit or receive electromagnetic waves of frequency substantially equal to 13.56 MHz.

5. The aerosol generation device according to claim 1, wherein the output data is encoded into the corresponding carrier wave using an amplitude-shift keying (ASK) technique.

6. The aerosol generation device according to claim 1, wherein the device communication module is configured to communicate with the external device according to a communication standard of type ISO/IEC 18092.

7. The aerosol generation device according to claim 1, wherein the device NFC antenna defines a rectangular shape with each side less than 15 mm.

8. The aerosol generation device according to claim 1, wherein the input and output data exchanged between the device communication module and the external device comprises at least one element chosen in the group:
user and/or aerosol generation device authentication data;
external device authentication data;
enabling/disabling data;
pairing data;
operational settings data;
status data;
diagnostics data; or
programming data.

9. The aerosol generation device according to claim 1, wherein said carrier wave is generated by the external device.

10. The aerosol generation device according to claim 1, wherein said carrier wave is generated by the device communication module.

11. A communication system comprising:
an aerosol generation device according to claim 1; and
an external device configured to communicate with the device communication module of the aerosol generation device.

12. The communication system according to claim 11, wherein the external device is configured to generate said input data to be received by the device communication module and encode the input data into a carrier wave to form said electromagnetic wave to be received by the device NFC antenna.

13. A communication method carried out by the communication system according to claim 11, comprising the following steps:
generating a carrier wave;
modulating the carrier wave to encode into the carrier wave the input data to form an electromagnetic wave;
receiving said electromagnetic wave; and
decoding the input data from said electromagnetic wave.

14. The communication method according to claim 13, further comprising the following steps:
processing the received input data and based on the processing, generating or extracting from a memory output data; and
transmitting the output data by modulating the carrier wave.
